(19) United States
(12) Patent Application Publication
(10) Pub. No.: US 2014/0244741 A1
(43) Pub. Date: Aug. 28, 2014

(54) Computer-Implemented System And Method For Context-Based APP Searching And APP Use Insights

(71) Applicant: STELLR, INC., Bellevue, WA (US)

(72) Inventors: David M. Lasky, Kirkland, WA (US); A!exandra Eikenbary, Bellevue, WA (US); Jing Leung, Snohomish, WA (US); Martin L. Holladay, Bremerton, WA (US); Yong Q. Lu, Shoreline, WA (US); Christopher J. Creighton, Sammamish, WA (US); Kelvin M. Hung, Sammamish, WA (US); Robert A. Roblin, Seattle, WA (US); Peter H. Benoit, Kirkland, WA (US); Michael B. Risse, Seattle, WA (US)

(73) Assignee: Stellr, Inc., Bellevue, WA (US)

(21) Appl. No.: 13/776,640

(22) Filed: Feb. 25, 2013

(51) Int. Cl. H04L 29/08

(52) U.S. Cl. CPC H04L 67/10
USPC 709/204

(57) ABSTRACT

A computer-implemented system and method for context-based APP searching and APP use insights are disclosed. User data is received from a plurality of mobile devices, each associated with at least one user. The user data includes context discriminators for each user and sensor data regarding the usage of applications on the users' mobile device. The data is stored and analyzed by an engine that identifies a list of names of applications used by each user on the user's mobile device. The engine provides to at least one user insights into applications used by other users by identifying the other users in a similar context to the at least one user based on their discriminators, and providing to the at least one user the names of one or more of the applications on the lists of applications used by the other users in the similar context.

### FIELD

This application relates in general to context-based searching and, in particular, to a computer-implemented system and method for context-based APP searching and APP use insights.

### BACKGROUND

The landscape of workplace automation has changed drastically from a traditional information technology (IT)-centric model of an installed and fully managed environment of desktop computers, network servers, and approved software. Rather users increasingly bring their own devices to the workplace, which they also use in their own endeavors, and with these devices introduce a mentality that they ought be the deciders of the most appropriate applications, that is, software, also referred to as “apps” or “APPs,” to run on their devices for any and all purposes, including job-related roles. However well intentioned their designs, these users are likely only aware of a small number of apps suitable to their needs and characteristics, particularly of a 1.4 million and growing number of applications available to users of devices running the iOS® and Android® operating systems, let alone the myriads of applications available for other operating systems and hardware platforms.

As a result of not being familiar with the myriads of existing app, these users may lack the tools necessary to become productive in a particular context and in a particular location. Finding the right applications for a given context becomes even harder due to these users having to balance a variety of personas that these users assume, with the different personas relating to different aspects of the users' lives. Thus, a persona of a product manager relating to a user's professional life requires a different set of applications to become productive than the same user's persona as a parent of a preschooler. The needs for each persona further change with the user's location. Thus, an attorney working under British Law in London, England, would need a different set of applications than an attorney in the same field working in Seattle, Washington.

Considering these complications, these users lack a way to effectively verify that the applications they currently use are indeed best-suited for a particular purpose, at a specific location, and for a particular persona. Furthermore, these users may not be aware of whole categories of applications that are useful for being productive in a particular context in a particular location, especially if these users are new to the location and to the context.

Existing technologies fail to provide the tools for identifying applications that would increase these users' productivity in a particular role or context. For example, search engines such as Yahoo!®, maintained by Yahoo! Inc. of Sunnyvale, Calif., allow a user to perform a keyword search of applications and to sort the applications based on ratings left by user raters. However, to conduct a search using such an engine requires a user to know the right keywords. A user new to a particular field may not know such keywords, making such search engines of nominal use to the user.

Similarly, the ratings of the applications may not be meaningful to a specific user. Such ratings are subjective and may be biased by a rater's relationship with a particular application's creator or distributor rather than based on the quality of the application. Even if unbiased, the majority of the raters may not be in the same context as the user searching and looking at the ratings. The applications useful to the raters in one context may be useless to the user in a different context. Furthermore, because the application ratings are averaged, the user has no way to tell how a particular rater rated an application; thus, even if the user had a reason to trust one rater over another, the user would have no way of identifying the trusted rating of a particular application. As a result, the ratings of applications do not provide the user with a meaningful way to navigate among the myriads of applications available.

Therefore, there is a need for a context-based way to search and provide insights on application use that would facilitate maximizing the productivity of a user in a specific context.

### SUMMARY

A computer-implemented system and method for context-based APP searching and APP use insights are disclosed. User data is received into a cloud-computing environment from a plurality of mobile devices, each associated with at least one user. The user data includes one or more context discriminators for each user and sensor data regarding the usage of applications on the users' mobile devices. Further discriminators can be received from social networks in which the user participates. The data is stored in a cloud storage and analyzed by a Cloud Analytics engine that identifies a list of names of applications used by each user on the user's mobile device. The engine provides to at least one user insights on applications used by other users. Providing the insights includes: identifying the other users in a similar context to the at least one user based on their discriminators, and providing to the at least one user the names of one or more of the applications used by the other users in the similar context.

The described system and method allow personas of all types, regardless of whether a persona is a business owner, a front line salesperson, an old hand, or a recent hire, to understand the applications that these personas need now, the applications they will want in the future as they grow in their career and lifestyle, and the applications that people use in an industry or community that these personas are interested in learning about. The described system and method deliver insight into the applications that power a user's professional and personal life, applications that enable a user to be more effective and successful. This insight is based on facts about the user: what the user does professionally, in what industry, what application the user already uses, how much the user travels, and other details that inform the Cloud Analytics engine on the best applications that people like the user use. Further, the insights provided improve over time as the user employs the system and method, allowing the user to stay current with access to the latest and most helpful app innovations. All of these advantages are accomplished while ensuring the user's complete privacy and control over the user's personal information.

Still other embodiments will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a high-level structural overview of a system for context-based searching and application-use insights in accordance with one embodiment.

FIG. 2 is a diagram showing a flow of information within the system of FIG. 1 in accordance with one embodiment.

FIG. 3 is a flow diagram showing a method for context-based searching and application use insights in accordance with one embodiment.

FIG. 4 is a flow diagram showing a routine for providing insights for the method of FIG. 3 in accordance with one embodiment.

FIG. 5 is a flow diagram showing a subroutine for providing insights into applications used by personas defined for other users for the routine of FIG. 4 in accordance with one embodiment.

FIG. 6 is a flow diagram showing an optional subroutine for providing insights into applications used by a user's social network connections for the routine of FIG. 4 in accordance with one embodiment.

### DETAILED DESCRIPTION

Glossary:

The following definitions are presented for the purposes of illustration, not limitation, and are presented in addition to the terms' established meanings. In addition to the definitions of terms specified below, the terms may be used within the application with their established meaning.

Register/UnRegister: Registering a device with the system when a user uses the system for the first time or removing the device registration from the system.

Share: Share the list of applications on a user's mobile device with others through means such as a social network post.

Settings: User interface presented by a mobile application that allows a user to enter data into the system.

Notifications: Updates received by a user regarding application use changes such as use of applications by other users or other personas.

Favorite: An application rank indicating that the application is important to the user.

Hide: A command preventing an application that the user does not wish to share or an application that is commonly used from being shared with other users.

Pull: A command pulling user discriminators from social networks profiles of the user.

Push: A command pushing the information the user would like to share or information regarding applications that the user has been recommended to social networks.

Sample: A snapshot of sensor data that includes a list of processes or applications running on a mobile device at a particular time at a particular location.

Taking into account a user's context when finding most appropriate applications for that user saves the user from the difficult task of searching myriads of available applications. Knowing this context allows identifying individuals or groups in a similar context and to providing insights into the applications used by the these individuals or groups to the user.

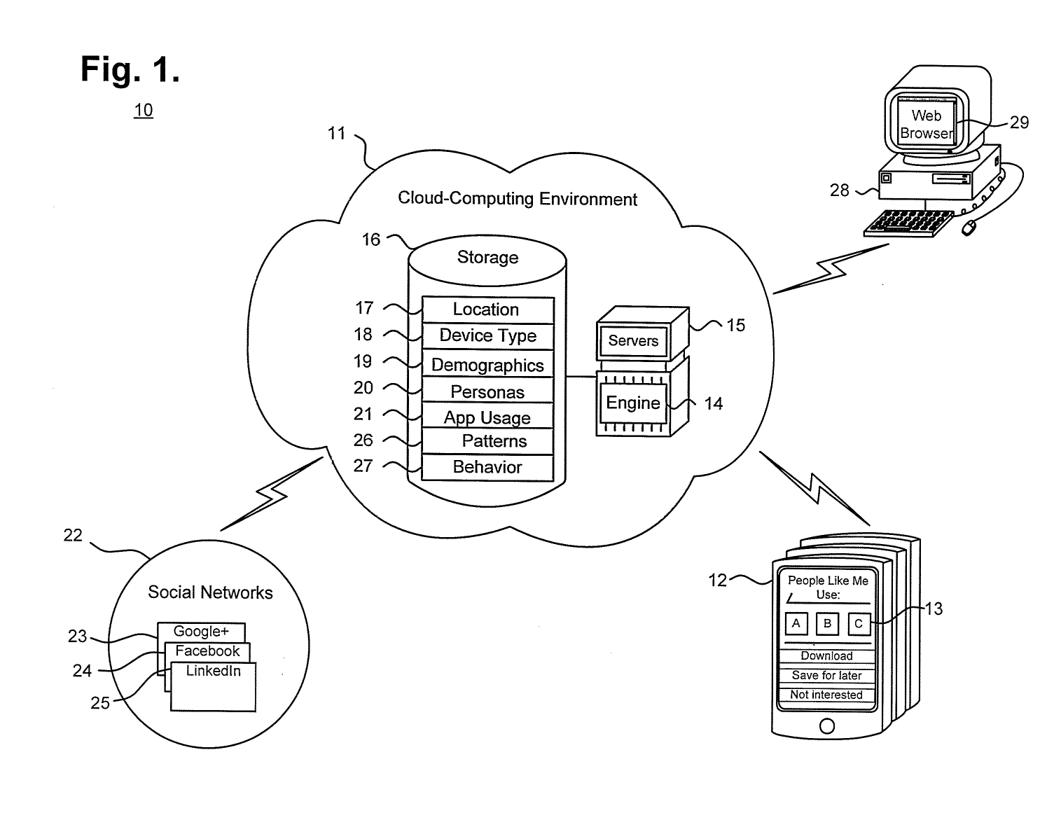

FIG. 1 is a block diagram showing a high-level structural overview of a system 10 for context-based searching and application use insights in accordance with one embodiment. The system 10 includes a cloud-computing environment 11 that is connected over the Internet or another network, such as a cellular network, to a plurality of user mobile devices 12, each executing a mobile application 13. The mobile devices 12 can include mobile phones, tablets, laptops, portable media players, and other devices capable of using downloadable applications. While in the described embodiment each user is associated with one mobile device, in a further embodiment, one user can be associated with multiple mobile devices 12. In a still further embodiment, multiple users can be associated with a single mobile device 12.

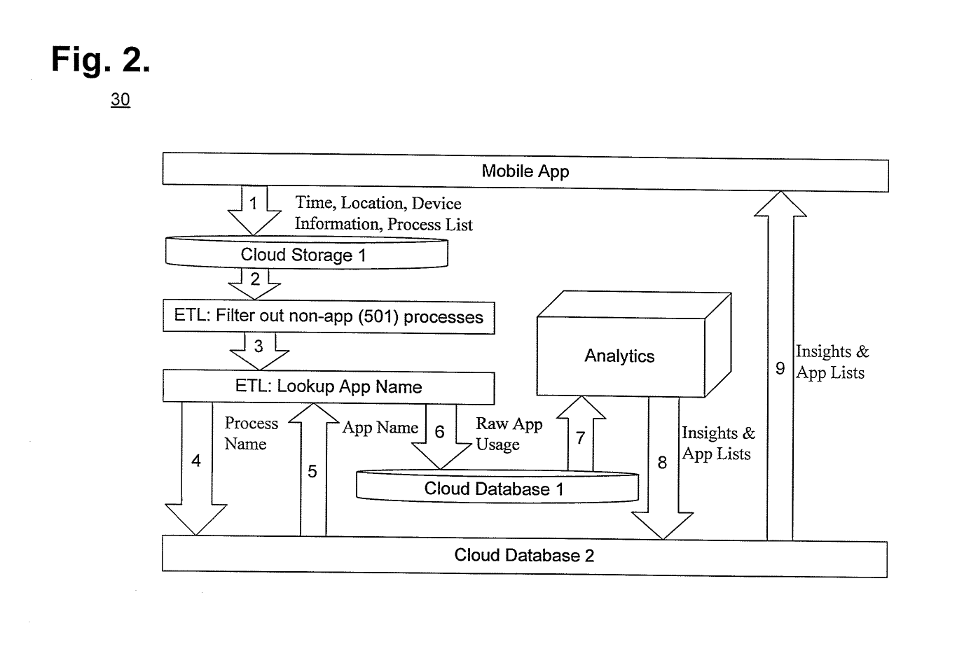

The cloud-computing environment 11 includes a Cloud Analytic engine 14 implemented by a plurality of servers 15. The engine 14 includes code, which can be implemented as modules. The engine 14, as described below, can process data from a variety of sources and provide insights into applications best for a particular user. Each server 15 can include components commonly found in computing devices such as a central processing unit (CPU), random access memory (RAM), non-volatile secondary storage, such as a hard drive or CD ROM drive, network interfaces, and peripheral devices, including user interfacing means, such as a keyboard and display. The cloud-computing environment 11 further includes storage devices 16 (“storage”), which can include one or more databases further discussed with reference to FIG. 2. The data stored by the storage 16 is accessible to the servers 15 implementing the engine 14. The engine 14 can include an Application Programming Interface (“API”) (not shown), which in one embodiment can be a Representation State Transfer (REST) API that sends and receives data from the mobile application 13. In particular, when a user registers a mobile device 12 with the system 10, the API generates a unique reference, and provides that reference to the mobile application 13 on the mobile device 12 and to the storage 16. Once both the storage 16 and the mobile application 13 have the reference, data from the mobile device 12 can be transferred directly into the storage 16. The use of the unique reference for storage and processing of the received user data allows to preserve the users' anonymity. No personal information is collected by the engine 14, with all data being anonymous.

The cloud-computing environment 11 receives user data from the mobile devices 12, which can be transmitted by the mobile application 13. The received data from the mobile devices 12 is transferred to the storage 16, from where the data can be retrieved by the engine 14 for processing. In one embodiment, the data can be stored as associative arrays in the Java Script Object Notation (“JSON”) format in a user key value store, such as mongoDB®, maintained by 10GEN, Inc. of New York, N.Y. In a further embodiment, the data can be transferred directly to the engine 14 for processing. The receipt of the data from the mobile device can be periodic or be triggered by some event, such as a user request or a change in the discriminators associated with a user.

The user data received from the mobile devices 12 includes discriminators for defining a context for finding applications for each user. Such discriminators can include a user's location 17, the type of device used 18, categories of applications used by the user or categories that the user wants insights about (not shown), and user demographics 19, such as a job role, level, company size, or work-related travel. The discriminators can be captured by the mobile application 13 from the mobile device 12 as well as entered into the settings of the mobile application 13 by the user.

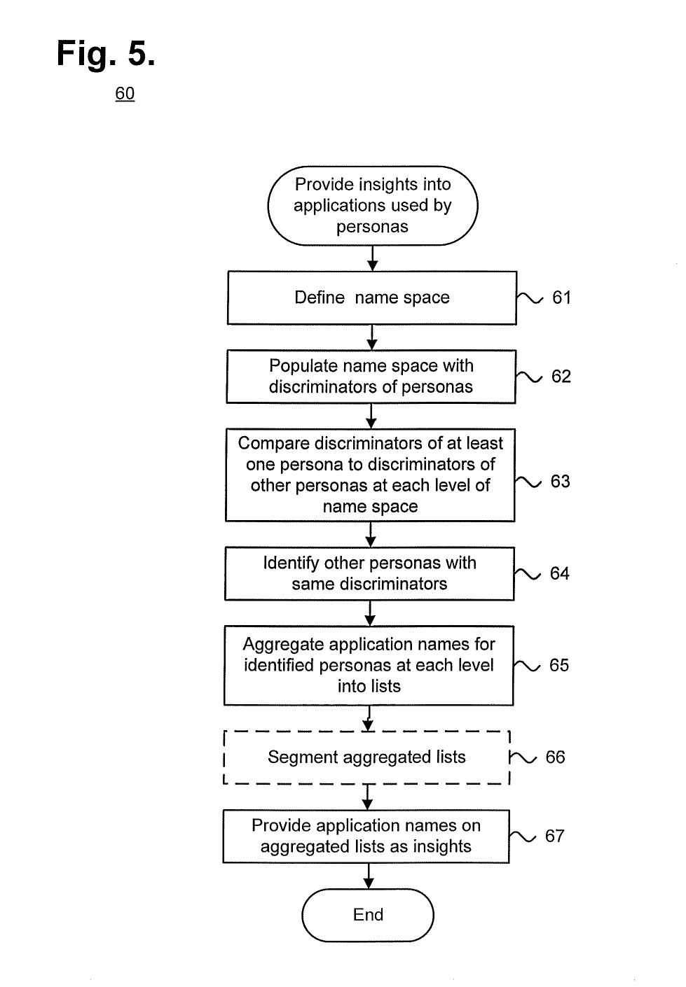

The received discriminators can further be associated with one or more personas 20 defined for a user, with different personas 20 describing different aspects of the user's context, such as being a technician by profession and being a triathlon runner in the user's personal life. Each persona 20 is associated with a set of discriminators. The user can define the personas 20 by entering the discriminators for the personas 20 into the settings of the mobile application 13. A user can have one or more personas 20. As described below with reference to FIG. 5, separate insights can be provided to each persona 20. In an embodiment where the user has only a single persona 20, all of the discriminators are associated with that persona 20, and the context for the persona is the same as the context for the user. The information regarding the different personas 20 can be stored in the storage 16. The received user data also includes sensor data: data regarding usage 21 of other applications on a mobile device 12, which was captured by the mobile application 13 on the mobile device 12. The sensor data includes a list of processes or applications running on the mobile device 12 at a particular point of time, at a particular location, before the cloud-computing environment 11 received the user data. The application usage information 21 can be stored in the storage 16. Other information can be included in the sensor data. In a further embodiment, the sensor data can serve as one of the discriminators. Additional discriminators associated with a particular user can be pulled into the cloud-computing environment 11 from a variety of social networks 22 in which the user participates, such as LinkedIn® 23, Facebook® 24, and Google+® 25. The engine 14 must receive user login information from the users of the social networks 22 to pull their data. The pulled information can include the demographic information 19, including membership in social network groups, social network activities, likes of social network items and users, and social network connections. The connections can include direct connections, such as Facebook® 24 friends and LinkedIn® 25 Connections with another user, as well as indirect connections such as members of the same social network groups as the particular user, and the social network members and groups that the user follows. User employment history can also be pulled if present on the social networks 22. Other discriminators can be pulled from the social networks 22. The pulled user data is processed by the engine 14, and is stored into the storage 16. In one embodiment, the discriminators pulled from the social network 22 can be associated with particular personas 20 of the user. For example, discriminators pulled from a professional social network can be associated with the user's professional persona 20.

The engine 14 can further generate additional discriminators by performing analytics on the received user data. For example, the engine 14 can process the user data to identify a list of applications used by a user (not shown), patterns 26 of application use, such as using several applications in a sequence, and user behavior 27, such as using particular applications in a particular location over a particular network. The engine 14 can further create a history (not shown) of applications downloaded by the user through the mobile application 13. The received and generated discriminators can be stored in the storage 16.

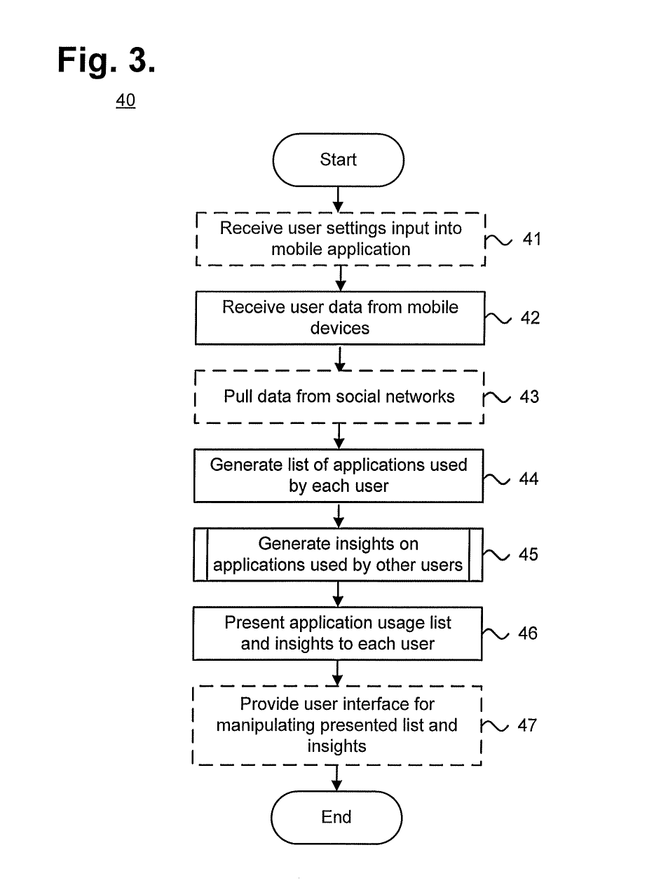

As mentioned above, the engine 14 generates a list of applications used by a particular user based on the received sensor data, as further described with reference to FIG. 3. In one embodiment, the sensor data is received multiple times at multiple time points, and the engine 14 aggregates the received data, providing the list of applications used by the user over the period of time. In a further embodiment, the engine 14 can use the sensor data at a single time to generate the list of applications used by the user associated with the device 12. The engine 14 can also aggregate the data for a group of users to generate a list of applications used by the group.

If multiple personas 20 are defined, each of the personas 20 can be associated with at some of the applications on the list. The association of applications with the personas 20 can be made prior to transmittal of the sensor data or after the generation of the list. For example, a mobile device can receive an indication from the user that the user is running applications for a particular persona at a particular point of time, with the indication being transmitted as part of the sensor data. Alternatively, the engine 14 can compare the applications on the list with a particular persona 20. For example, an accounting application will be associated with the user's accounting persona. Other ways to make the association are possible.

The engine 14 further provides to a user insights into applications used by other users, or groups of other users, who are in a context similar to the each user's context, as further described with reference to FIGS. 3 through 6. The insights can be transmitted to the mobile application 13 via the Internet or another network, such as a cellular network, and presented to the user by the mobile application 13 on a display of the mobile device 12. The information regarding the user's own application usage can also be transmitted to the user's mobile device 12.

In a further embodiment, the insights and the list of applications used by a user can be accessed by the user or another person who has the user's access information to the cloud-computing environment 11 through a computing device 28, such as a desktop computer, through a web browser 29 connected to the Internet. In a still further embodiment, the user can share the presented insights and the list of used applications by pushing them via the engine 14 to the social networks 22.

The flow of information in the system 10 involves the use of storage databases that are part of the storage 16 and that are accessible to the engine 14. FIG. 2 is a diagram showing a flow of information 30 between the cloud-computing environment 11 and the mobile application 14 within the system 10 of FIG. 1 in accordance with one embodiment. The user data that includes the location 17 of the mobile device 12, information identifying the mobile device 12, the time the information is sent, and the list of processes running on the mobile device 12 at the time, is pushed into an online database (“Cloud Database 1”), such as the S3 storage maintained by Amazon.com Inc. of Seattle, Wash. (step 1). Other user discriminators can be pushed into S3. The data undergoes an Extract-Transform-Process (“ETL”) process, with non-application processes being filtered out (step 2). The non-application processes include user processes and processes hardwired on the mobile device 12 such as processes on a known daemon-processes list. After being filtered, the data undergoes another round of ETL processing: the list of filtered processes is transferred into another cloud database (“Cloud Database 2”) (step 4). In one embodiment, Cloud Database 2 can be mongoDB® key value store or document store maintained by 10GEN, Inc. of New York, N.Y. Cloud Database 2 can store a dictionary of application names corresponding to process names. By comparing the name of the processes on the list to the dictionary, the list of process names can be converted into the list of application names (step 5). In a further embodiment, if the name of an application corresponding to a process cannot be identified using the dictionary, the system 10 can recommend the user to use another application to find the name of a particular process. In a still further embodiment, the filtering of non-application processes and identification of the names of the processes can be performed on the mobile device 12 by the mobile application 13.

Once the applications names are identified, the names are transferred Cloud Database 1 (step 6), creating a record of raw application usage on the mobile device at a particular time for the user. The raw application usage data for multiple users stored in Cloud Database 1 undergo analytics performed by the engine 14 (step 7), and application usage list, either at a particular time point or over a period of time, is generated for each user. The insights into application use by users and groups of users in the similar context are also generated via the analytics, as further described with reference to FIGS. 3 through 6. In one embodiment, the analytics can be implemented using the Elastic Map/Reduce (“EMR”) service offered by Amazon.com Inc. of Seattle, Wash. The application usage list and the insights are stored into Cloud Database 2 (step 8), from where they can be transmitted by the engine 14 back to the mobile application 13 (step 9) for display on the mobile device 12. Other ways for information to flow in the system 10 of FIG. 1 are possible.

The discriminators collected by the system 10 allow defining a context for providing insights into application use by others to a particular user. FIG. 3 is a flow diagram showing a method 40 for context-based searching and application use insights in accordance with one embodiment.

Initially, a user can optionally input data into the settings of the mobile application 13 (step 41), including defining one or more personas 20 and associating the discriminators with the personas 20. In a further embodiment, the user can enter discriminators relating to what a user aspires to be, such as being a member of a certain profession, or being in a certain location. Additionally, the user can give the permissions to the mobile application 13 to use a positioning device within the mobile device 12, such as a GPS, to establish the user's position. The user can further provide social network login information to the application 13. The user can input data into the settings the first time when the user uses the mobile application 13 or during subsequent sessions of the application 13 use.

Once the user inputs data into the settings of the mobile application 13, the cloud-computing environment 11 begins receiving user data from the mobile devices 12, the data including one or more discriminators for each user, including the discriminators entered in step 41, and the sensor data for each user (step 42). The data can be transmitted to the cloud-computing environment 11 in regular intervals, providing the system 10 with information about a user's application use over a period of time. In a further embodiment, the data can be transmitted when one of the discriminators, such as the user's location 17, changes, or upon a request of the user. Other triggers for the data transmission are possible.

Optionally, the engine can pull additional discriminators, including the users' social network membership and connections from the social networks 22 (step 43).

Following the receipt of the user data (step 42), the engine 14 analyzes the data to generate a list of applications used by each user (step 44). In one embodiment, the engine 14 can aggregate sensor data samples received over a period of time, and produce a list of applications used by a user over that period of time. In a further embodiment, the engine can generate the list of applications used by the user at a particular time point from a single sample of sensor data. In a still further embodiment, the applications used by members of a group can be aggregated to provide the list of applications used by the group. The application usage lists can include the names of the applications used and the amount of usage for each application. Applications can be ordered in the lists by the amount of usage. Applications meeting a certain threshold for usage can be identified as favorite applications.

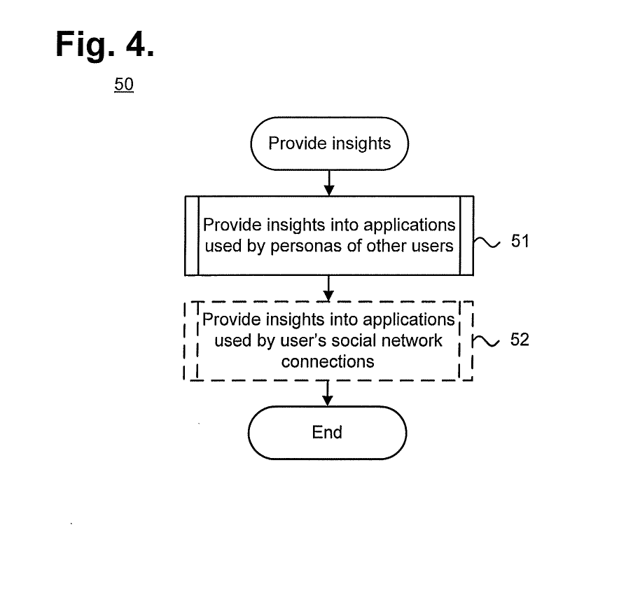

After generating the application usage lists for a plurality of users, the engine provides to at least one of the users insights into applications used by other entities, such as users or groups of users, based on the context of the at least one user (step 45), as further described in detail with reference to FIGS. 4 through 6. The insights are provided into applications used by entities, such as individual users or groups of users, that are in a context similar to the context to the context of the at least one user. A particular user is in a similar context to other users or groups of others user if the particular user is connected to the other users or groups of the other users through the social networks 22. The particular user is also in a similar context to another user if the user, or one of the personas 20 defined for the user, has one or more common discriminators with the another user or the personas 20 defined for the another user. If the discriminators associated with a particular persona 20 are compared to the personas 20 defined for the other users, separate insights can generated for every persona 20 of that user.

Following their generation, the list of applications used by a user and the insights for that user are presented to the user (step 46). The presentation can be done via the mobile application 13 on the display of the mobile device 12, or via a web-browser 29 from another computing device 28. In a further embodiment, a user can receive a notification, such as an e-mail notification that the insights and the list of applications have been generated for that user and are ready to be presented. In a still further embodiment, only the insights are presented to the user.

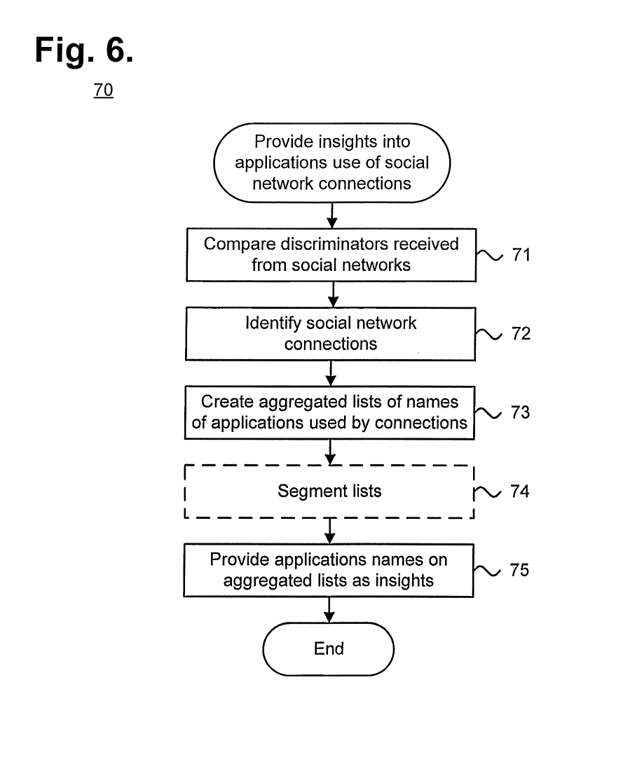

During the presentation (step 46), the applications can be sorted and presented by categories. For example, applications can be presented in the order of amount of use, and applications identified as favorite applications can be presented separately. Similarly, the insights can be segmented and presented by persona, specific discriminators within the persona, application category, and location of the users into whose application use the insight is given, as further described with reference to FIGS. 5 and 6. The insights on other users that are in the similar context can be presented in the “PeopleLikeMe” category. Similarly, insights on applications used by entities, whether individual users or groups, that the user follows on the social networks 22 can be separately presented in the “PeoplelFollow” and “GroupslFollow” categories respectively. In a further embodiment, the user can be presented with a list of applications that are trending with users or groups that the user follows; an application is considered trending when the percentage of the entities the user follows using an application passes a threshold amount. In a still further embodiment, the applications that the user has previously been recommended and marked as interesting can be presented in a separate category; these applications can be presented in the “SaveForLater” category. The applications can be similarly be sorted within the presentation categories based on the amount of usage. Other presentation categories and category names are possible.

In addition to being presented with the application list and the insights, the system 10 can optionally receive user commands for manipulating the presented information via a user interface, which can be presented as part of the mobile application 13 (step 47), terminating the method 50. For example, the user can use the interface to share the information regarding the user's application usage and favorite applications on the social networks 22. The user can also share the insights on the social networks 22. The user can further choose to hide certain applications the user uses, preventing these applications from being shared. The user can further mark and unmark applications as favorite applications. In a further embodiment, the user can edit the list of used applications and add applications whose use the system 10 has not detected. The user can further use the interface to download the applications provided in the insights, to add an application provided in the insights to the list of applications that the user is not interested in, and to mark the applications that the user is interested in but does not want to download at the moment to be included into the “SaveForLater” category. Other actions are possible. In a further embodiment, the actions taken are used for subsequent filtering of the insights. For example, applications that the user has indicated as being not interest in can be filtered out of the future insights. Similarly, applications that the user has saved for later download or has already downloaded to the user's mobile device 12 can be similarly filtered out.

Providing the relevant insights to a user requires determining other users or groups of users who are in a context similar to the context of that user. FIG. 4 is a flow diagram showing a routine 50 for providing insights for the method 40 of FIG. 3 in accordance with one embodiment. The insights are provided to each persona for a user based on the similarity of the discriminators associated with personas 20 for the user to discriminators associated with personas 20 for other users (step 51), as further described with reference to FIG. 5. Optionally, the insights are provided into application use by the other users or groups of other users connected to the user in the social networks (step 52), as further described with reference to FIG. 6, terminating the routine 50.

FIG. 5 is a flow diagram showing a subroutine 60 for providing insights into applications use of personas 20 defined for other users for the routine 50 of FIG. 4 in accordance with one embodiment.

A namespace is defined within the storage 16 to organize the discriminators received in steps 41 through 43 (step 61). The described name space includes a hierarchy of levels. In the described embodiment, level 0 is at the top of the hierarchy, and level 4 is at the bottom of the hierarchy. The name space described below is presented for illustrative purposes, and not for purposes of limitation. Other organizations of the name space can be used. Other discriminator names as name space options can be used.

In defining the name space, the discriminators associated with the personas 20 are organized into a number of levels. At level 0, the discriminators define whether a persona 20 relates to a user's professional life or the user's personal life. Level 1 organizes the discriminators relating to the users' “Role.” If a persona 20 relates to a user's professional life, the discriminators define the persona's 20 professional role, with the discriminator options including a “Technician,” “Sales Person,” “Marketing Person,” “Product Manager,” “Designer,” and “Office manager.” If a persona 20 relates to the user's personal life, the discriminators options include “Parent” and other personal roles. In the described embodiment, the name space includes two levels for a persona relating to a user' personal life: level 0 and level 1. In a further embodiment, any number of levels can be used to organize the discriminators for a persona 20 related to the user's personal life.

The professional personas 20 discriminators are further organized at level 2, which holds the discriminators describing the users' professional “Level,” with the discriminator options including “Freelance,” “Individual,” “Manager,” and “Executive.” Level 3 of the name space, “Company Size,” holds discriminators describing a size of the users' companies. The discriminator options at Level 3 include “Small/Startup,” “Mid-Size,” and “Enterprise.”

The final level for the embodiment, level 4, the “Work Travel” level organizes discriminators indicating the amount work-related travel the users do. The discriminator options for level 4 are “None/infrequent,” “Local Travel,” and “Road Warrior.”

Once the name space is defined (step 61), the name space is populated with the discriminators associated with the personas 20 received in steps 41 through 43 (step 62). Once the levels are populated (step 62), the engine 14 compares at each level the discriminators associated with a particular persona 20 defined for the one user to whom the insights are directed to the discriminators associated with the personas 20 defined for the other users (step 63). Based on the comparison (step 63), for each level, the engine identifies all of the other personas 20 that are associated with the same discriminators as the particular persona 20 on that level and at all the levels higher in the hierarchy (step 64). For each level, the names of the applications used by the other personas 20 identified in step 64 are aggregated into a list (step 65).

The following example illustrates steps 64 and 65 for a professional persona 20 whose associated discriminator at level 1 is “Product Manager,” discriminator at level 2 is “Freelancer,” discriminator at level 3 is “Mid-Size,” and discriminator at level 4 is “Road Warrior.” At level 1, the engine 14 would identify (step 64) all of the other professional personas 20 associated with a “Product Manager” role and would create an aggregated list of names of the applications used by these identified personas 20 (step 65). At level 2, the engine 14 would identify all of the other professional personas 20 associated with the “Freelancer” discriminator at level 2 and the “Product Manager” discriminator at level 1 (step 64), and create an aggregated list of names of the applications used by these identified personas 20 (step 65). At level 3, the engine 14 would identify all of the other professional personas 20 with the “Mid-Size” discriminator at level 3, “Freelancer” discriminator at level 2, and the “Product Manager” discriminator at level 1 (step 64), and create an aggregated list of names of the applications used by these identified personas 20 (step 65). Finally, at level 4, the engine 14 would identify all of the other professional personas 20 with the “Road Warrior” discriminator at level 4, “Mid-Size” discriminator at level 3, “Freelancer” discriminator at level 2, and the “Product Manager” discriminator at level 1 (step 64), and create an aggregated list of names of the applications used by these identified personas 20 (step 65). Thus, at least four aggregated lists used by the professional personas 20 in a context similar to the context of the particular persona 20 are created.

The aggregated lists of application names can be optionally segmented prior to being provided to the user as insights (step 66). The list for each persona 20 can be segmented by location of the other personas 20. For example, if personas 20 identified for a level at step 64 come from Seattle, Wash., and London, England, the aggregated list can be segmented by the two locations. The aggregated lists can also be segmented by a category of applications, with a separate list being created for each category. For example, if the aggregated list of applications used by professional personas 20 in a “Product Manager” role includes travel and game applications, the list can be segmented into the list of travel applications and the list of game applications used by users with the personas 20. Other types of segmentation are possible. In a further embodiment, the aggregated lists can be segmented in multiple ways. For example, an aggregated list can be segmented by categories of applications used by personas 20 in particular locations.

Following the optional segmentation, one or more of the names of the applications on the aggregated lists or their segments are provided to a user as insights for the particular persona (step 67), terminating the subroutine 60.

Insights can also be provided into applications used by a user's social network connections. FIG. 6 is a flow diagram showing an optional subroutine 70 for providing insights into applications used by a user's social network connections for the routine 50 of FIG. 4. Discriminators received from the social networks 22, which include social network membership and connections, for the particular user are compared to the discriminators received from the social networks 22 for the other users (step 71). Other users connected to the user in the social networks 22 are identified based on the comparison (step 72). An aggregated list of names of applications used by at least some of the social network connections is created (step 73). In a further embodiment, a separate list is created for each type of social network connections; thus there would be separate lists of names of applications used by the social network friends of the user and other users that the particular user follows on the social networks 22. The lists can optionally be segmented (step 74) by the location of the social network connections, category of applications, types of social network connections, and other discriminators. Names of applications from the lists or the segmented lists are provided to the user as insights (step 75), terminating the routine.

While the invention has been particularly shown and described as referenced to the embodiments thereof, those skilled in the art will understand that the foregoing and other changes in form and detail may be made therein without departing from the spirit and scope of the invention.

What is claimed:

1. A computer-implemented method for context-based searching and app use insights, comprising the steps of:
receiving user data from a plurality of mobile devices associated with a plurality of users, the user data comprising names of applications used on each mobile device and one or more context discriminators associated with each of the users;
storing the user data in a storage;
generating lists of names of one or more application used by each of the users on at least one associated mobile device based on the stored user data;
providing to at least one of the users insights on application use of at least a portion of the plurality's other users, comprising:
identifying the other users in a context similar to a context of the at least one user based on the discriminators associated with the at least one user and the other users;
providing as the insights to the at least one user one or more of the application names on the lists for the users in the similar context.

2. A method according to claim 1, further comprising:
defining one or more personas for each of the users, each persona associated with at least some of the discriminators associated with the user for which the persona was defined and at least some of the application names on the list for the user for which the persona was defined;
comparing one or more of the discriminators associated with at least one persona for the at least one user to the discriminators associated with the personas for the other users; and
finding the other personas in a context similar to the context of the at least one persona based on the comparison.

3. A method according to claim 2, further comprising:
organizing the context discriminators associated with the personas in a hierarchical name space within the storage comprising a top level and one or more lower levels in the name space hierarchy;
identifying for each level the personas for the other users having the same discriminators as the at least one persona at that level and all of the levels higher in the hierarchy; and
generating an aggregated list of the names of the applications associated with the personas identified at each level.

4. A method according to claim 1, further comprising:
receiving from one or more social networks further context discriminators for the at least one user and at least a portion of the other users;
comparing the further context discriminators associated with the one user to the further context discriminators associated with at least the portion of the other users and identifying based on the comparison the at least one user's social network connections; and
setting the social network connections as the other users in the similar context to the one user.

5. A method according to claim 4, further comprising at least one of:
providing the list of names of the applications used by the at least one user to the at least one user;
sharing on the one or more social networks the names of the one or more of the applications provided to the at least one user as a part of at least one of the list and the insights.

6. A method according to claim 4, wherein the social network connections comprise one or more of the other users directly connected to the at least one user, the other users who are part of the same social network group as the at least one user, the other users whom the at least one user follows in the one or more of the social networks, and the other users in a group that the at least one user follows in the one or more social networks.

7. A method according to claim 1, further comprising:
segmenting the insights based on one or more of the other users' location, the at least one user's personas, categories of applications, and types of social network connections between the at least one user and the other users.

8. A method according to claim 1, further comprising at least one of:
identifying the names of the applications comprised in the user data, comprising:
receiving a list of names of processes used on at least one of the mobile devices;
filtering out the names of the processes corresponding to non-application processes;
comparing the filtered list to a dictionary comprising a list of process names and corresponding application names; and
converting the names of the processes to the names of the applications.

9. A method according to claim 1, further comprising:
generating from the user data additional context discriminators comprising at least one of patterns of application use, user behavior, and history of application downloads.

10. A method according to claim 1, wherein the one or more discriminators for each user comprise one or more of the user's location, a type of device associated with the user, application categories that the user is interested in, and user demographics comprising one or more of the user's job role, job level, company size, and an indicator of amount of work-related travel.

11. A computer-implemented system for context-based searching and application use insights, comprising the steps of:
a storage to receive and store user data from a plurality of mobile devices associated with a plurality of users, the user data comprising names of applications used on each mobile device and one or more context discriminators associated with each of the users;
a plurality of servers, each comprising a processor and memory, configured to execute an analytics engine, comprising:
a generation module configured to generate lists of names of one or more applications used by each of the users on at least one associated mobile device based on the stored user data;
an insight module configured to provide to at least one of the users insights on application use of at least a portion of the plurality's other users, comprising:
an identification module configured to identify the other users in a context similar to a context of the at least one user based on the discriminators associated with the at least one user and the other users;
a provision module configured to provide as the insights to the at least one user the names of one or more of the applications on the lists for the users in the similar context.

12. A system according to claim 11, further comprising:
a definition module configured to define one or more personas for each of the users, each persona associated with at least some of the discriminators associated with the user for which the persona was defined and at least some of the application names on the list for the user for which the persona was defined;
a comparison module configured to compare one or more of the discriminators associated with at least one persona for the at least one user to the discriminators associated with the personas for the other users; and
a context module configured to find the other personas in a context similar to the context of the at least one persona based on the comparison.

13. A system according to claim 12, further comprising:
a namespace module configured to organize the context discriminators associated with the personas in a hierarchical name space within the storage comprising a top level and one or more lower levels in the name space hierarchy;
a group module configured to identify for each level the personas for the other users having the same discriminators as the at least one persona at that level and all of the levels higher in the hierarchy; and
a generation module configured to generate an aggregated list of the names of the applications associated with the personas identified at each level.

14. A system according to claim 11, further comprising:
a receipt module configured to receive from one or more social networks further context discriminators for the at least one user and at least a portion of the other users;
a connection module configured to compare the further context discriminators associated with the one user to the further context discriminators associated with at least the portion of the other users and identifying based on the comparison the at least one user's social network connections; and
a similarity module configured to set the social network connections as the other users in the similar context to the one user.

15. A system according to claim 14, further comprising at least one of:
a generation module configured to provide the list of applications used by the at least one user to the at least one user;
a sharing module configured to share on the one or more social networks the names of the one or more of the applications provided to the at least one user as a part of at least one of the list and the insights.

16. A system according to claim 14, wherein the social network connections comprise one or more of the other users directly connected to the at least one user, the other users who are part of the same social network group as the at least one user, the other users whom the at least one user follows in the one or more of the social networks, and the other users in a group that the at least one user follows in the one or more social networks.

17. A system according to claim 11, further comprising:
a segmentation module configured to segment the insights based on one or more of the other users' location, the at least one user's personas, categories of applications, and types of social network connections between the at least one user and the other users.

18. A system according to claim 11, further comprising at least one of:
a naming module configured to identify the names of the applications comprised in the user data, comprising:
a process name module configured to receive a list of names of processes used on at least one of the mobile devices;
a filtering module configured to filter out the names of the processes corresponding to non-application processes;
a dictionary module configured to compare the filtered list to a dictionary comprising a list of process names and corresponding application names; and
a conversion module configured to convert the names of the processes to the names of the applications.

19. A system according to claim 11, further comprising:
a discriminator module to generate from the received user data additional context discriminators comprising at least one of patterns of application use, user behavior, and history of application downloads.

20. A system according to claim 11, wherein the one or more discriminators for each user comprise one or more of the user's location, a type of device associated with the user, application categories that the user is interested in, and user demographics comprising one or more of the user's job role, job level, company size, and an indicator of amount of work-related travel.
